(19) United States
(12) Patent Application Publication
(10) Pub. No.: US 2024/0314541 A1
(43) Pub. Date: Sep. 19, 2024

(54) SYSTEMS AND METHODS FOR PROVIDING ANALYTICS IDENTIFIER IN SUBSCRIPTION CHANGE NOTIFICATION

(71) Applicant: ZTE Corporation, Shenzhen (CN)

(72) Inventors: Xiaojian YAN, Shenzhen (CN); Jinguo ZHU, Shenzhen (CN)

(73) Assignee: ZTE Corporation, Shenzhen (CN)

(21) Appl. No.: 18/614,018

(22) Filed: Mar. 22, 2024

Related U.S. Application Data
(63) Continuation of application No. PCT/CN2022/126367, filed on Oct. 20, 2022.

(51) Int. Cl. H04W 8/20; H04W 24/00

(52) U.S. Cl. CPC H04W 8/20; H04W 24/00

(57) ABSTRACT

Presented are systems and methods for providing at least one analytics identifier (ID) in subscription change notifications. A target data analytics function (DAF) may accept a transfer of at least one analytics subscription from a source DAF to the target DAF. The at least one analytics subscription may be associated with a new subscription correlation identifier (ID). The target DAF may send a notification message to an analytics consumer. The target DAF may comprise the new subscription correlation ID and an identification of the at least one analytics subscription.

### CROSS-REFERENCE TO RELATED APPLICATION

This application claims the benefit of priority under 35 U.S.C. § 120 as a continuation of International Patent Application No. PCT/CN2022/126367, filed on Oct. 20, 2022, the disclosure of which is incorporated herein by reference in its entirety.

### TECHNICAL FIELD

The disclosure relates generally to wireless communications, including but not limited to systems and methods for providing at least one analytics identifier (ID) in subscription change notifications.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A target data analytics function (DAF) (e.g., network data analytics function (NWDAF)) may accept a transfer of at least one analytics subscription from a source DAF to the target DAF. The at least one analytics subscription may be associated with a new subscription correlation identifier (ID) (e.g., allocated/assigned by the target NWDAF). The target DAF may send a notification message (e.g., a Nnwdaf_EventsSubscription_Notify request message) to an analytics consumer. The target DAF may comprise the new subscription correlation ID and an identification of the at least one analytics subscription. The identification of the at least one analytics subscription can include at least one of: an ID number, a name, a group number, an index of a table, or an item number. The notification message may further comprise at least one of: an old subscription correlation ID associated with (e.g., allocated/assigned by) the source DAF, or a notification correlation ID.

In some embodiments, the analytics consumer may determine to modify or delete at least one other analytics subscription (e.g., those analytics subscription(s) remaining with the source NWDAF), according to the identification of the at least one analytics subscription. The analytics consumer may send a request to the source DAF to modify or delete the at least one other analytics subscription.

In some embodiments, the analytics consumer may determine to modify or delete one or more of the at least one analytics subscription (e.g., those analytics subscription(s) transferred to the target NWDAF), according to the identification of the at least one analytics subscription. The analytics consumer may send a request to the target DAF to modify or delete the one or more of the at least one analytics subscription. In some embodiments, the at least one analytics subscription may consist of all analytics subscriptions that can be subscribed by the analytics subscription from the source DAF.

In some embodiments, a second target DAF may accept a transfer of at least one other analytics subscription from the source DAF to the second target DAF. The at least one other analytics subscription can be associated with a second new subscription correlation identifier (ID). The second target DAF may send a second notification message to the analytics consumer. The second notification message may comprise the second new subscription correlation ID and an identification of the at least one other analytics subscription. The analytics consumer may determine to modify or delete the at least one other analytics subscription, according to the identification of the at least one analytics subscription. The analytics consumer may send a request to the second target DAF to modify or delete the at least one other analytics subscription.

In some embodiments, a second target DAF may accept (e.g., assume, receive) a transfer of one or more analytics subscriptions of the at least one analytics subscription from the target DAF to the second target DAF. The one or more analytics subscriptions can be associated with a second new subscription correlation identifier (ID). The second target DAF may send a second notification message to the analytics consumer. The second notification message may comprise the second new subscription correlation ID and an identification of the one or more analytics subscription. The analytics consumer may determine to modify (e.g., update, change) or delete (e.g., terminate/end, discontinue, unsubscribe from) the one or more analytics subscriptions, according to the identification of the one or more analytics subscriptions. The analytics consumer may send a request to the second target DAF to modify or delete the one or more analytics subscriptions.

In some embodiments, the analytics consumer may determine to modify or delete at least one analytics subscription remaining with the source DAF, according to the identification of the at least one analytics subscription. The analytics consumer may send a request to the source DAF to modify or delete the at least one analytics subscription remaining with the source DAF.

In some embodiments, the analytics consumer may determine to modify or delete at least one analytics subscriptions remaining with the target DAF, according to the identification of the at least one analytics subscription and the identification of the one or more analytics subscriptions. The analytics consumer may send a request to the target DAF to modify or delete the at least one analytics subscriptions remaining with the target DAF.

In some embodiments, an analytics consumer may receive a notification message (e.g., a Nnwdaf_EventsSubscription_Notify request message) from a target data analytics function (DAF). The notification message may comprise (i) a new subscription correlation identifier (ID) associated with at least one analytics subscription transferred from a source DAF to the target DAF, and (ii) an identification of the at least one analytics subscription.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example analytics exposing architecture in a 5G system, in accordance with some embodiments of the present disclosure;

FIG. 4 illustrates a sequence diagram for analytics subscription operations, in accordance with some embodiments of the present disclosure;

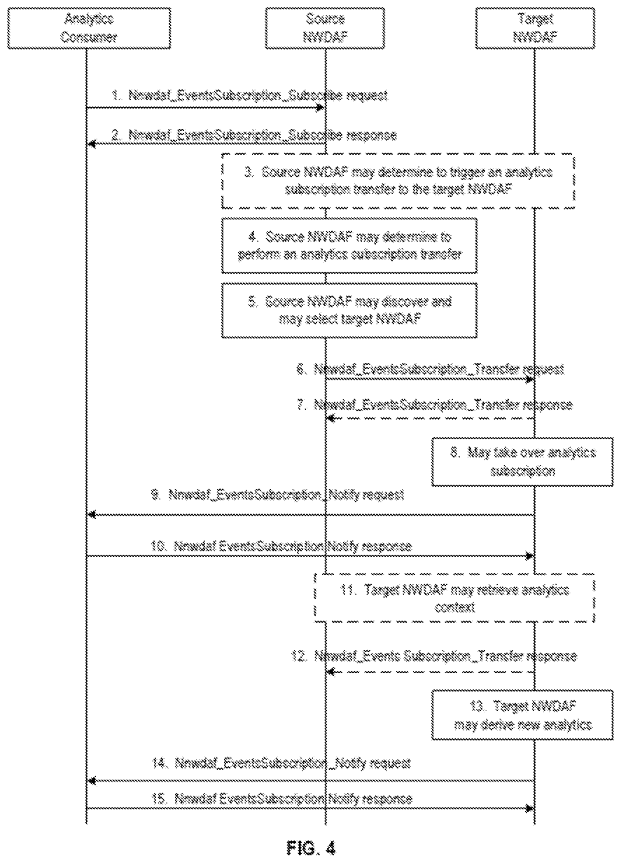

FIG. 5 illustrates a sequence diagram for analytics subscription operations, in accordance with some embodiments of the present disclosure;

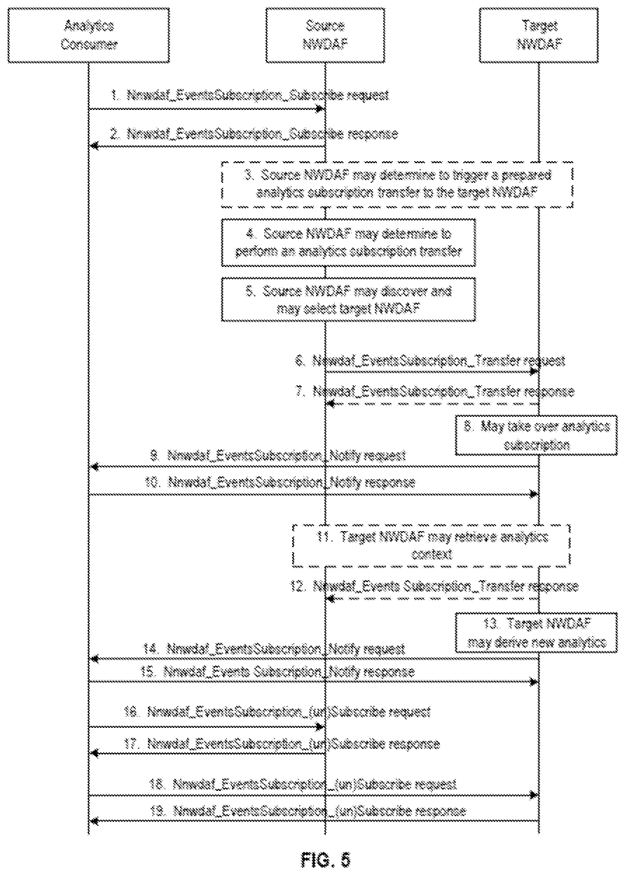

FIG. 6 illustrates a sequence diagram for analytics subscription operations, in accordance with some embodiments of the present disclosure;

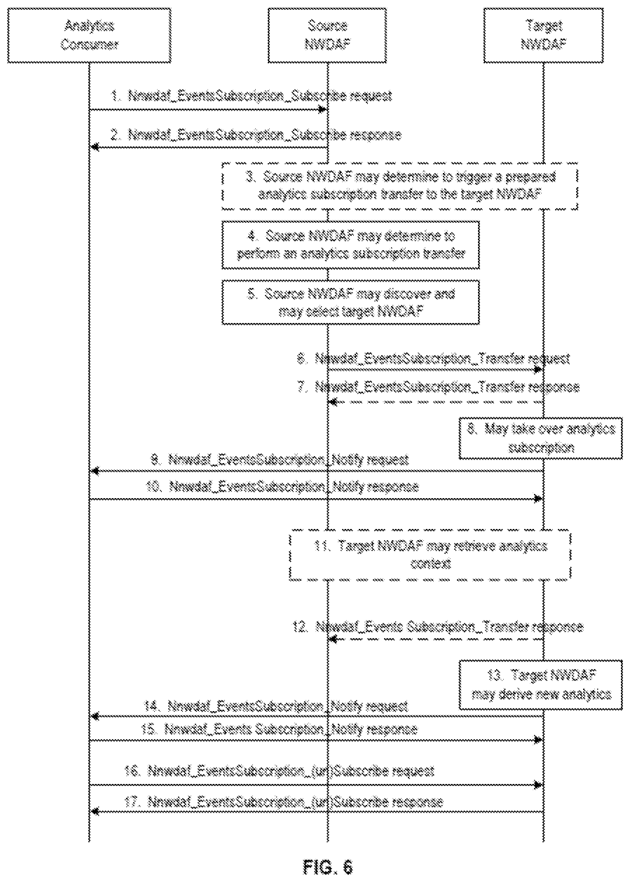

FIG. 7 illustrates a sequence diagram for analytics subscription operations, in accordance with some embodiments of the present disclosure;

FIG. 8 illustrates a sequence diagram for analytics subscription operations, in accordance with some embodiments of the present disclosure; and

FIG. 9 illustrates a flow diagram for providing at least one analytics identifier (ID) in a subscription change notification, in accordance with an embodiment of the present disclosure.

### DETAILED DESCRIPTION

### 1. Mobile Communication Technology and Environment

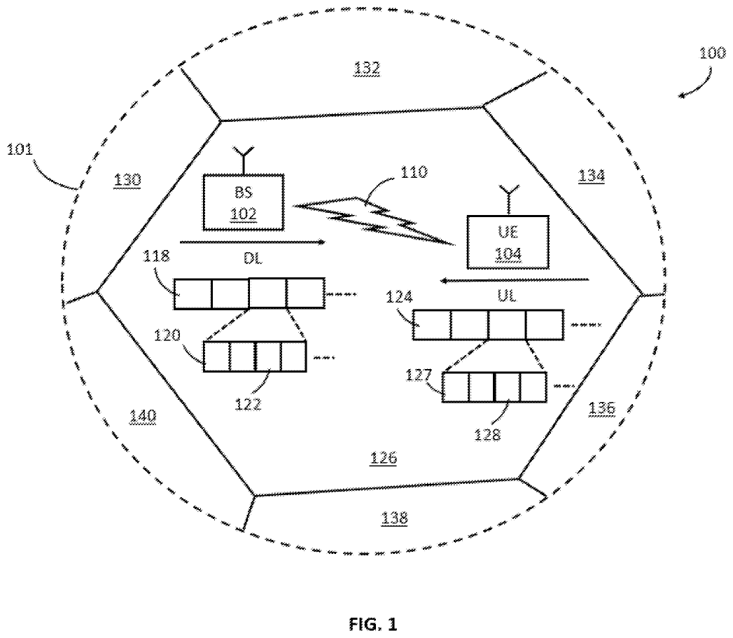

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

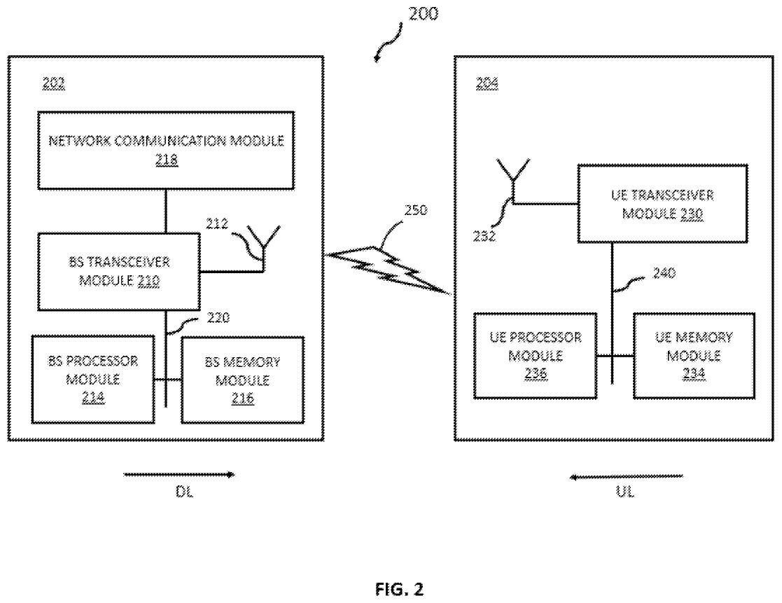

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (cNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Providing Analytics Identifier (ID) in Subscription Change Notification

A network data analytics function (NWDAF) may transfer one or more of its analytics subscriptions to another NWDAF instance due to internal (e.g., load balancing, graceful shutdown) and/or external triggers (e.g. user equipment (UE) mobility). An analytics subscription transfer procedure can be done/accomplished/executed for all subscriptions or for a selected subset of subscriptions related to specific area(s), specific analytics identifier (ID)(s), specific network function (NF)(s), and/or specific UE(s).

In order to collect data from user equipment, network functions and/or operations, administration, and maintenance (OAM) systems, the NWDAF may extract data from microservice functions residing inside a network core so that relevant data can be analyzed at scale. Analytics (e.g., comprising the data or derived/generated from the data) may include for example at least one of: analysis of different types of network data and statistics to identify trends and patterns, or analysis of network/performance problems (e.g., packet loss, throughput, or latency). The analytics may be generated and/or provided by the NWDAF, and may provide insight into what devices can be (e.g., device type, function, operating mode) on the network and how the device communicates with each other. The analytics may also compare and correlate analytics of a device with other devices' data/analytics. An analytics consumer can request and/or subscribe to one or more specific analytics that an NWDAF can provide/produce. At least one of these analytics subscriptions may be transferred to another NWDAF, to deliver the corresponding analytics to the analytics consumer.

When a target NWDAF takes over one or more analytics subscriptions, the target NWDAF may inform/notify an analytics consumer about successful transfer of analytics subscription(s) from another NWDAF via a subscription change notification. The notification may include a new subscription correlation ID which was assigned by the target NWDAF, and an old subscription correlation ID which was allocated by the source NWDAF. The analytics consumer may replace the old subscription correlation ID with the new subscription correlation ID. The analytics consumer may use the new subscription correlation ID for further management of the corresponding subscription(s) (e.g., to modify or delete some or all of the corresponding subscriptions).

However, in the case that the source NWDAF transfers a subset of its analytics subscriptions to the target NWDAF, for the remaining analytics subscriptions which are still kept in the source NWDAF, the analytics consumer may not be able to modify or delete the remaining analytics subscriptions using the old subscription correlation ID since the old subscription correlation ID may already be replaced with the new one.

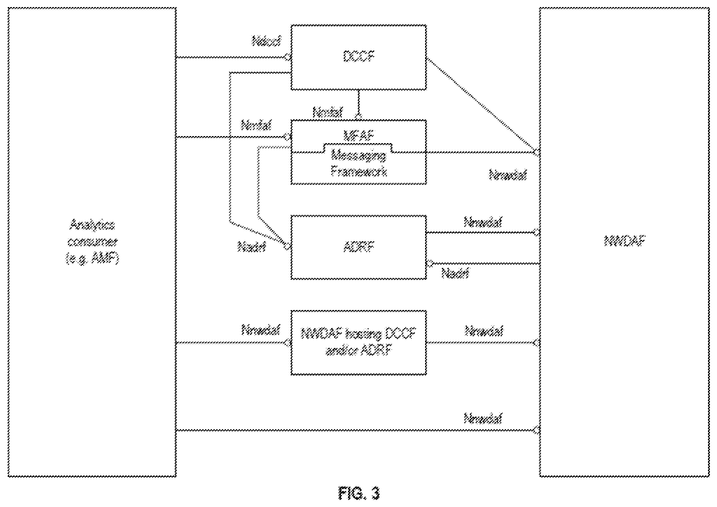

FIG. 3 illustrates an example analytics exposing architecture in a 5G system. A NWDAF may expose (e.g., generate, provide, yield, output, publish) analytics result(s) to any 5G core (5GC) network function (NF) (e.g., an access and mobility management function (AMF)) directly or via data collection coordination function (DCCF)/messaging framework adapter function (MFAF). The analytics exposing architecture may include at least one of following functions: an analytic consumer (e.g., AMF), a data collection coordination function (DCCF), a messaging framework adaptor function (MFAF), an analytics data repository function (ADRF), and/or a network data analytics function (NWDAF).

The analytics consumer can provide/include functionality to manage at least one (un)subscription to a notification of analytics information from the NWDAF. The DCCF may provide a functionality to coordinate collection of analytics and/or data from one or more NFs based on request(s) from one or more NF service consumers. The MFAF may provide a functionality to allow NF consumers to configure or reconfigure a behavior of mapping data and/or analytics received by the MFAF to out-bound notification endpoints. The ADRF may provide a functionality to allow NF consumers to store, retrieve, and/or remove data or analytics from the ADRF. The NWDAF may provide analytics information for different analytics events to NF service consumers. An NWDAF instance can request a transfer of analytics subscription(s) to another NWDAF instance.

### Implementation Example 0: Analytics Subscription Transferring Procedure Initiated by a Source NWDAF

In step 1, an analytics consumer may send a request message (e.g., an Nnwdaf_EventsSubscription_Subscribe request) to subscribe to at least one (e.g., type of) analytics from a source NWDAF. The request may include an identification of the analytics being subscribed by the analytics consumer, a notification uniform resource identifier (URI), and/or a notification correlation ID.

In step 2, the source NWDAF may assign (e.g., generate, allocate) a subscription correlation ID associated with the at least one analytics subscription. The source NWDAF may send a response message (e.g., an Nnwdaf_EventsSubscription_Subscribe response) to the analytics consumer. The response message may include the subscription correlation ID.

In step 3 (e.g., optional step), based on an external and/or an internal trigger, the source NWDAF may determine to prepare an analytics subscription transfer (e.g., a transfer of at least one analytics subscription of the analytics consumer, that was subscribed from the source NWDAF) to a target NWDAF. The source NWDAF may discover one or more candidate target NWDAFs (e.g., NWDAF-Y and NWDAF-Z). The NWDAF may send a request message (e.g., Nnwdaf_EventsSubscription_Transfer) to the one or more candidate target NWDAFs. The request message may include an indication information (e.g., a prepared analytics subscription transfer indication) in the request message. The one or more candidate target NWDAFs (e.g., NWDAF-Y and NWDAF-Z) may start data collection from network functions (NFs) or operations, administration, and maintenance (OAM), and may start analytics generations for the indicated analytics subscriptions. The source NWDAF may determine to select a target NWDAF (e.g., NWDAF-Y) from the one or more candidate target NWDAFs. The source NWDAF may send a request message (e.g., Nnwdaf_EventsSubscription_Transfer) to the selected target NWDAF (e.g., NWDAF-Y) to ask the selected target NWDAF to take over at least one analytics subscription from the source NWDAF. The source NWDAF may cancel the prepared analytics subscription transfer to the other candidate target NWDAF-Z. The selected target NWDAF can take over the at least one analytics subscription from the source NWDAF in a short time if there is a preparation step.

In step 4, the source NWDAF may determine to initiate an analytics subscription transfer from the source NWDAF to one or more other NWDAFs. The source NWDAF may determine one or more analytics subscriptions to transfer, and may determine to perform an analytics subscription transfer (of the one or more determined analytics subscriptions) to the target NWDAF. The source NWDAF may determine one or more analytics subscriptions to be transferred to the target NWDAF, e.g., based on a load, capability, processing capacity of the source NWDAF and/or the target NWDAF.

In step 5, the source NWDAF may perform an NWDAF discovery and may select the target NWDAF (e.g., from a plurality of target/candidate NWDAFs). The NWDAF discovery may be skipped if the target NWDAF had already been discovered as part of a prepared analytics subscription transfer.

In step 6, the source NWDAF may send a request message (using an Nnwdaf_EventsSubscription_Transfer service operation) to transfer the one or more analytics subscriptions determined in step 4 to the target NWDAF. The request message may include/identify/specify the analytics subscriptions being transferred, and if not provided during a prepared analytics subscription transfer, a notification URI, and/or a notification correlation ID received by the source NWDAF in step 1 from the analytics consumer.

In step 7 (e.g., optional step), the target NWDAF may send a response message (e.g., an Nnwdaf_EventsSubscription_Transfer response) to the source NWDAF (e.g., in response to the request message).

In step 8, the target NWDAF may accept a transfer of at least one analytics subscription (e.g., one or more analytics subscriptions determined in step 4, and/or identified in the request message) from the source DAF to the target DAF. The target NWDAF may take over/receive the at least one analytics subscription (e.g., to perform generation of the analytics for consumption by the analytics consumer) based on the information received from the source NWDAF. If not yet done during a prepared analytics subscription transfer, the target NWDAF may allocate a new subscription correlation ID to the received/transferred analytics subscriptions.

In steps 9 and 10, the target NWDAF may inform/notify the analytics consumer about the successful analytics subscription transfer using a (e.g., Nnwdaf_EventsSubscription_Notify) request message. A new subscription correlation ID assigned/allocated by the target NWDAF and the old subscription correlation ID assigned/allocated by the source NWDAF can be provided/included/identified in the (e.g., Nnwdaf_EventsSubscription_Notify) request message. The request message may include the notification correlation ID which allows the analytics consumer to correlate the notifications to the initial subscription request made with the source NWDAF in step 1. The analytics consumer may send a response message (e.g., an Nnwdaf EventsSubscription Notify response) to the target NWDAF (e.g. in response to the request message).

In step 11 (e.g., conditional step), if “analytics context identifier(s)” had been included in the Nnwdaf_EventsSubscription_Transfer Request received by the target NWDAF in step 6, the target NWDAF may request the “analytics context” by invoking the Nnwdaf_AnalyticsInfo_ContextTransfer service operation.

In step 12 (e.g., optional step), the target NWDAF may confirm (e.g., confirm acceptance of) the analytics subscription transfer by sending a (e.g., Nnwdaf_EventsSubscription_Transfer) response message to the source NWDAF, if the response message has not been sent in step 7.

In step 13, the target NWDAF may (e.g., perform analysis or processing to) derive/generate new output analytics based on new input data.

In steps 14 and 15, the target NWDAF may notify/inform the analytics consumer about the new analytics using a subscription change notification or a notify message (e.g., an Nnwdaf_EventsSubscription_Notify message).

The target NWDAF may include an identification of the transferred analytics in the subscription change notification, which can enable the analytics consumer to identify which subscribed analytics are transferred and which are not, so that the analytics consumer can use the new subscription correlation ID for the transferred analytics subscriptions and use the old correlation subscription ID for the analytics subscriptions remaining with the source NWDAF.

### Implementation Example 1: Part of Subscribed Analytics are Transferred from a Source NWDAF to a Target NWDAF

In step 1, an analytics consumer may send a request message (e.g., an Nnwdaf_EventsSubscription_Subscribe request) to subscribe to at least one (e.g., type of) analytics from a source NWDAF. The request message may include the analytics being subscribed by the analytics consumer, a notification uniform resource identifier (URI), and/or a notification correlation ID.

In step 2, the source NWDAF may assign (e.g., generate, allocate) a subscription correlation ID associated with the at least one analytics subscription. The source NWDAF may send a response message (e.g., an Nnwdaf_EventsSubscription_Subscribe response) to the analytics consumer. The response message may include the subscription correlation ID.

In step 3 (e.g., optional step), the source NWDAF may determine to prepare an analytics subscription transfer (e.g., a transfer of at least one analytics subscription of the analytics consumer, that was subscribed from the source NWDAF) for part of subscribed analytics to target NWDAF according to a trigger. For example, the trigger for the transfer can be due to a load balancing issue. The source NWDAF may discover one or more candidate target NWDAFs (e.g., NWDAF-Y and NWDAF-Z). The NWDAF may send a request message (e.g., Nnwdaf_EventsSubscription_Transfer) to the one or more candidate target NWDAFs. The request message may include an indication information (e.g., a prepared analytics subscription transfer indication) in the request message. The one or more candidate target NWDAFs (e.g., NWDAF-Y and NWDAF-Z) may start data collection from network functions (NFs) or operations, administration, and maintenance (OAM), and may start analytics generations for the indicated analytics subscriptions. The source NWDAF may determine to select a target NWDAF (e.g., NWDAF-Y) from the one or more candidate target NWDAFs. The source NWDAF may send a request message (e.g., Nnwdaf_EventsSubscription_Transfer) to the selected target NWDAF (e.g., NWDAF-Y) to ask the selected target NWDAF to take over at least one analytics subscription from the source NWDAF. The source NWDAF may cancel the prepared analytics subscription transfer to the other candidate target NWDAF-Z. The selected target NWDAF can take over the at least one analytics subscription from the source NWDAF in a short time if there is a preparation step.

In step 4, the source NWDAF may determine to initiate an analytics subscription transfer from the source NWDAF to one or more other NWDAFs. The source NWDAF may determine one or more analytics subscriptions to transfer, and may determine to perform an analytics subscription transfer (of the one or more determined analytics subscriptions) to the target NWDAF. The source NWDAF may determine one or more analytics subscriptions to be transferred to the target NWDAF, e.g., based on a load, capability, processing capacity of the source NWDAF and/or the target NWDAF.

In step 5, the source NWDAF may perform an NWDAF discovery and may select the target NWDAF (e.g., from a plurality of target/candidate NWDAFs). The NWDAF discovery may be skipped if the target NWDAF had already been discovered as part of a prepared analytics subscription transfer.

In step 6, the source NWDAF may send a request message (using an Nnwdaf_EventsSubscription_Transfer service operation) to transfer the one or more analytics subscriptions determined in step 4 to the target NWDAF. The request message may include/identify/specify the analytics subscriptions being transferred, and if not provided during a prepared analytics subscription transfer, a notification URI, and/or a notification correlation ID received by the source NWDAF in step 1 from the analytics consumer.

In step 7 (e.g., optional step), the target NWDAF may send a response message (e.g., an Nnwdaf_EventsSubscription_Transfer response) to the source NWDAF (e.g., in response to the request message).

In step 8, the target NWDAF may accept a transfer of at least one analytics subscription (e.g., one or more analytics subscriptions determined in step 4, and/or identified in the request message) from the source DAF to the target DAF. The target NWDAF may take over/receive the at least one analytics subscription (e.g., to perform generation of the analytics for consumption by the analytics consumer) based on the information received from the source NWDAF. If not yet done during a prepared analytics subscription transfer, the target NWDAF may allocate a new subscription correlation ID to the received/transferred analytics subscriptions.

In steps 9 and 10, the target NWDAF may inform/notify the analytics consumer about the successful analytics subscription transfer, using a (e.g., Nnwdaf_EventsSubscription_Notify) request message. A new subscription correlation ID assigned/allocated by the target NWDAF, the transferred analytics ID (e.g., a list of analytics ID), and the old subscription correlation ID assigned/allocated by the source NWDAF can be provided/included/identified in the (e.g., Nnwdaf_EventsSubscription_Notify) request message. The request message may include the notification correlation ID which allows the analytics consumer to correlate the notifications to the initial subscription request made with the source NWDAF in step 1. The analytics consumer may send a response message (e.g., an Nnwdaf EventsSubscription Notify response) to the target NWDAF (e.g. in response to the request message).

In step 11 (e.g., a conditional step), if “analytics context identifier(s)” had been included in the Nnwdaf_EventsSubscription_Transfer Request received by the target NWDAF in step 6, the target NWDAF may request the “analytics context” by invoking the Nnwdaf_AnalyticsInfo_ContextTransfer service operation.

In step 12 (e.g., optional step), the target NWDAF may confirm (e.g., confirm acceptance of) the analytics subscription transfer by sending a (e.g., Nnwdaf_EventsSubscription_Transfer) response message to the source NWDAF, if the response message has not been sent in step 7.

In step 13, the target NWDAF may (e.g., perform analysis or processing to) derive/generate new output analytics (e.g., for a transferred analytics subscription) based on new input data.

In steps 14 and 15, the target NWDAF may notify/inform the analytics consumer about the new analytics using a subscription change notification or a notify message (e.g., an Nnwdaf_EventsSubscription_Notify message).

In steps 16 and 17, the analytics consumer may modify or delete at least one other analytics subscription at the source NWDAF by sending a request message (e.g., an Nnwdaf_EventsSubscription_Subscribe request or an Nnwdaf_EventsSubscription_Unsubscribe service operation) to the source NWDAF. The analytics consumer may know/be aware of which subscription(s) are still at the source NWDAF, based on the transferred analytics ID. The request message may include the old subscription correlation ID assigned by the source NWDAF and received by the analytics consumer in step 2. The source NWDAF may send a response message (e.g., an Nnwdaf_EventsSubscription_(un)Subscribe response) to the analytics consumer.

In steps 18 and 19, the analytics consumer may modify or delete one or more of the at least one analytics subscription at the target NWDAF by sending a request message (e.g., an Nnwdaf_EventsSubscription_Subscribe or an Nnwdaf_EventsSubscription_Unsubscribe service operation). The analytics consumer may determine/know/be aware of which subscription(s) can be at the target NWDAF, based on the transferred analytics ID. The request message may include the new subscription correlation ID assigned by the target NWDAF received by the analytics consumer in step 9. The target NWDAF may send a response message (e.g., an Nnwdaf_EventsSubscription_(un)Subscribe response) to the analytics consumer.

The target NWDAF may include/incorporate an identification of the transferred analytics in the subscription change notification, which can enable the analytics consumer to identify which subscribed analytics are transferred and which are not, so that the analytics consumer can use the new subscription correlation ID for the transferred analytics subscriptions, and use the old correlation subscription ID for the analytics subscriptions remaining with the source NWDAF.

### Implementation Example 2: All Subscribed Analytics are Transferred from a Source NWDAF to a Target NWDAF

In step 1, an analytics consumer may send a request message (e.g., an Nnwdaf_EventsSubscription_Subscribe request) to subscribe to at least one (e.g., type of) analytics from a source NWDAF. The request may include an identification of the analytics being subscribed by the analytics consumer, a notification uniform resource identifier (URI), and/or a notification correlation ID.

In step 2, the source NWDAF may assign (e.g., generate, allocate) a subscription correlation ID associated with the at least one analytics subscription. The source NWDAF may send a response message (e.g., an Nnwdaf_EventsSubscription_Subscribe response) to the analytics consumer. The response message may include the subscription correlation ID.

In step 3 (e.g., optional step), the source NWDAF may determine to prepare an analytics subscription transfer (e.g., a transfer of all analytics subscription of the analytics consumer, that was subscribed from the source NWDAF) of subscribed analytics to a target NWDAF according to a trigger. For example, the trigger can be due to initiation or scheduling of a graceful shutdown. The source NWDAF may discover one or more candidate target NWDAFs (e.g., NWDAF-Y and NWDAF-Z). The NWDAF may send a request message (e.g., Nnwdaf_EventsSubscription_Transfer) to the one or more candidate target NWDAFs. The request message may include an indication information (e.g., a prepared analytics subscription transfer indication) in the request message. The one or more candidate target NWDAFs (e.g., NWDAF-Y and NWDAF-Z) may start data collection from network functions (NFs) or operations, administration, and maintenance (OAM), and may start analytics generations for the indicated analytics subscriptions. The source NWDAF may determine to select a target NWDAF (e.g., NWDAF-Y) from the one or more candidate target NWDAFs. The source NWDAF may send a request message (e.g., Nnwdaf_EventsSubscription_Transfer) to the selected target NWDAF (e.g., NWDAF-Y) to ask the selected target NWDAF to take over at least one analytics subscription from the source NWDAF. The source NWDAF may cancel the prepared analytics subscription transfer to the other candidate target NWDAF-Z. The selected target NWDAF can take over the at least one analytics subscription from the source NWDAF in a short time if there is a preparation step.

In step 4, the source NWDAF may determine to initiate an analytics subscription transfer from the source NWDAF to one or more other NWDAFs. The source NWDAF may determine all analytics subscriptions to transfer, and may determine to perform an analytics subscription transfer (of all the determined analytics subscriptions) to the target NWDAF. The source NWDAF may determine that all analytics subscriptions are to be transferred to the target NWDAF, e.g., based on a load, capability, processing capacity of the source NWDAF and/or the target NWDAF.

In step 5, the source NWDAF may perform an NWDAF discovery and may select the target NWDAF (e.g., from a plurality of target/candidate NWDAFs). The NWDAF discovery may be skipped if the target NWDAF had already been discovered as part of a prepared analytics subscription transfer.

In step 6, the source NWDAF may send a request message (using an Nnwdaf_EventsSubscription_Transfer service operation) to transfer all the analytics subscriptions determined in step 4 to the target NWDAF. The request message may include/identify/specify the analytics subscriptions being transferred, and if not provided during a prepared analytics subscription transfer, a notification URI, and/or a notification correlation ID received by the source NWDAF in step 1 from the analytics consumer.

In step 7 (e.g., optional step), the target NWDAF may send a response message (e.g., an Nnwdaf_EventsSubscription_Transfer response) to the source NWDAF (e.g., in response to the request message).

In step 8, the target NWDAF may accept a transfer of all analytics subscription (e.g., all analytics subscriptions determined in step 4, and/or identified in the request message) from the source DAF to the target DAF. The target NWDAF may take over/receive the analytics subscription (e.g., to perform generation of the analytics for consumption by the analytics consumer) based on the information received from the source NWDAF. If not yet done during a prepared analytics subscription transfer, the target NWDAF may allocate a new subscription correlation ID to the received/transferred analytics subscriptions.

In steps 9 and 10, the target NWDAF may inform/notify the analytics consumer about the successful analytics subscription transfer using a (e.g., Nnwdaf_EventsSubscription_Notify) request message. A new subscription correlation ID assigned/allocated by the target NWDAF, the transferred analytics ID(s) (e.g., a list of analytics IDs), and the old subscription correlation ID assigned/allocated by the source NWDAF can be provided/included/identified in the (e.g., Nnwdaf_EventsSubscription_Notify) request message. The request message may also include the notification correlation ID which can allow the analytics consumer to correlate the notifications to the initial subscription request made with the source NWDAF in step 1. The analytics consumer may send a response message (e.g., an Nnwdaf EventsSubscription Notify response) to the target NWDAF (e.g. in response to the request message).

In step 11 (e.g., conditional step), if “analytics context identifier(s)” had been included in the Nnwdaf_EventsSubscription_Transfer Request received by the target NWDAF in step 6, the target NWDAF may request the “analytics context” by invoking the Nnwdaf_AnalyticsInfo_ContextTransfer service operation.

In step 12 (e.g., optional step), the target NWDAF may confirm (e.g., confirm acceptance of) the analytics subscription transfer by sending a (e.g., Nnwdaf_EventsSubscription_Transfer) response message to the source NWDAF, if the response message has not been sent in step 7.

In step 13, the target NWDAF may (e.g., perform analysis or processing to) derive/generate new output analytics (corresponding to the transferred analytics subscriptions) based on new input data.

In steps 14 and 15, the target NWDAF may notify/inform the analytics consumer about the new analytics using a subscription change notification or a notify message (e.g., an Nnwdaf_EventsSubscription_Notify message).

In steps 16 and 17, the analytics consumer may modify or delete (using the analytics ID(s)) one or more of the analytics subscription transferred to the target NWDAF, by sending a request message (e.g., an Nnwdaf_EventsSubscription_Subscribe or an Nnwdaf_EventsSubscription_Unsubscribe service operation). The analytics consumer may know/be aware of which subscription(s) can be at the target NWDAF, based on the transferred analytics ID(s). The request message may include the new subscription correlation ID assigned by the target NWDAF received by the analytics consumer in step 9. The target NWDAF may send a response message (e.g., an Nnwdaf_EventsSubscription_(un)Subscribe response) to the analytics consumer.

The target NWDAF may include an identification of the transferred analytics in the subscription change notification, which can enable the analytics consumer to identify which subscribed analytics have been transferred and which are not, so that the analytics consumer can use the new subscription correlation ID for the transferred analytics subscriptions and use the old correlation subscription ID for the analytics subscriptions remaining/kept/retained with the source NWDAF.

All subscribed analytics can be transferred to a target NWDAF from a source NWDAF. The source NWDAF may not indicate to the target NWDAF that all analytics subscriptions are being transferred in the request message to the target NWDAF. Hence, the target NWDAF may not be able to know whether all or some of the subscribed analytics have been transferred by the source NWDAF. Therefore, to ensure that the target NWDAF is able to accurately associate a new subscription correlation ID with the transferred subscriptions, the target NWDAF may simply/always include the list of subscriptions being transferred, together with a new corresponding subscription correlation ID, each time it receives a transfer. That is, from the perspective of the target NWDAF, the newly added identification of the transferred subscriptions can be mandatory for reporting to the analytics consumer.

### Implementation Example 3: Subscribed Analytics are Transferred to Different Target NWDAFs

In step 1, an analytics consumer may send a request message (e.g., an Nnwdaf_EventsSubscription_Subscribe request) to subscribe to at least one (e.g., type of) analytics (e.g., analytics ID 1, 2, and 3 subscriptions) from a source NWDAF. The request may include the analytics being subscribed by the analytics consumer, a notification uniform resource identifier (URI), and/or a notification correlation ID.

In step 2, the source NWDAF may assign (e.g., generate, allocate) a subscription correlation ID associated with the at least one analytics subscription (e.g., analytics subscription IDs 1, 2, and 3). The source NWDAF may send a response message (e.g., an Nnwdaf_EventsSubscription_Subscribe response) to the analytics consumer. The response message may include the subscription correlation ID.

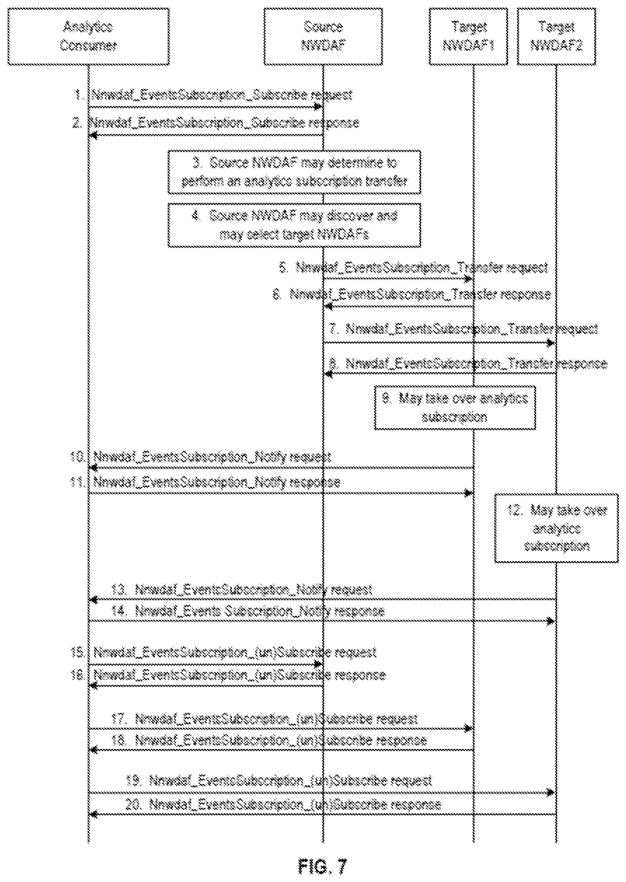

In some embodiments, a preparation step (not shown in FIG. 7) can be performed. The source NWDAF may determine to perform the preparation step. In the preparation step, the source NWDAF may discover one or more candidate target NWDAFs (e.g., NWDAF-Y and NWDAF-Z). The NWDAF may send a request message (e.g., Nnwdaf_EventsSubscription_Transfer) to the one or more candidate target NWDAFs. The request message may include an indication information (e.g., a prepared analytics subscription transfer indication) in the request message. The one or more candidate target NWDAFs (e.g., NWDAF-Y and NWDAF-Z) may start data collection from network functions (NFs) or operations, administration, and maintenance (OAM), and may start analytics generations for the indicated analytics subscriptions. The source NWDAF may determine to select a target NWDAF (e.g., NWDAF-Y) from the one or more candidate target NWDAFs. The source NWDAF may send a request message (e.g., Nnwdaf_EventsSubscription_Transfer) to the selected target NWDAF (e.g., NWDAF-Y) to ask the selected target NWDAF to take over at least one analytics subscription from the source NWDAF. The source NWDAF may cancel the prepared analytics subscription transfer to the other candidate target NWDAF-Z. The selected target NWDAF can take over the at least one analytics subscription from the source NWDAF in a short time if there is a preparation step.

In step 3, based on an external and/or an internal trigger, the source NWDAF may determine to initiate an analytics subscription transfer from the source NWDAF to one or more other NWDAFs. The source NWDAF may determine one or more (e.g., analytics subscription IDs 1 and 2) of the at least one analytics subscriptions to transfer, and may determine to perform an analytics subscription transfer (of the one or more determined analytics subscriptions) to one or more target NWDAFs. The source NWDAF may determine one or more analytics subscriptions to be transferred to the one or more target NWDAFs, e.g., based on a load, capability, processing capacity of the source NWDAF and/or the one or more target NWDAFs.

In step 4, the source NWDAF may perform an NWDAF discovery and may select the one or more target NWDAFs (e.g., from a plurality of target/candidate NWDAFs). For example, the source NWDAF may select target NWDAF1 and target NWDAF2 to which to transfer subscriptions with analytics subscription ID 1 and analytics subscription ID 2, respectively.

In step 5, the source NWDAF may send a request message (using an Nnwdaf_EventsSubscription_Transfer service operation) to transfer analytics subscription ID 1 to the target NWDAF1. The request message may include/identify/specify the analytics subscription (e.g., ID 1) being transferred, a notification URI, and/or a notification correlation ID received by the source NWDAF in step 1 from the analytics consumer.

In step 6, the target NWDAF1 may send a response message (e.g., an Nnwdaf_EventsSubscription_Transfer response) to the source NWDAF (e.g., in response to the request message).

In step 7, the source NWDAF may send a request message (using an Nnwdaf_EventsSubscription_Transfer service operation) to transfer analytics subscription(s) (e.g., ID 2) to the target NWDAF2. The request message may include/identify/specify the analytics subscription(s) (e.g., ID 2) being transferred, a notification URI, and/or a notification correlation ID received by the source NWDAF in step 1 from the analytics consumer.

In step 8, the target NWDAF2 may send a response message (e.g., an Nnwdaf_EventsSubscription_Transfer response) to the source NWDAF (e.g., in response to the request message).

In step 9, the target NWDAF1 may accept a transfer of at least one analytics subscription (e.g., analytics subscription ID 1) from the source NWDAF to the target NWDAF 1. The target NWDAF1 may take over/receive the at least one analytics subscription (e.g., to perform generation of the analytics for consumption by the analytics consumer) based on the information received from the source NWDAF. The target NWDAF1 may allocate a new subscription correlation ID (e.g., subscription correlation ID 1) to the received/transferred analytics subscriptions.

In steps 10 and 11, the target NWDAF1 may inform/notify the analytics consumer about the successful analytics subscription transfer using a (e.g., Nnwdaf_EventsSubscription_Notify) request message. A new subscription correlation ID assigned/allocated by the target NWDAF1, the transferred analytics ID (e.g., analytics subscription ID 1), and the old subscription correlation ID assigned/allocated by the source NWDAF can be provided/included/identified in the (e.g., Nnwdaf_EventsSubscription_Notify) request message. The request message may also include the notification correlation ID which may allow the analytics consumer to correlate the notifications to the initial subscription request made with the source NWDAF in step 1. The analytics consumer may send a response message (e.g., an Nnwdaf EventsSubscription Notify response) to the target NWDAF1 (e.g. in response to the request message).

In step 12, the target NWDAF2 may accept a transfer of at least one analytics subscription (e.g., analytics subscription ID 2) from the source NWDAF to the target NWDAF2. The target NWDAF2 may take over/receive the at least one analytics subscription (e.g., to perform generation of the analytics for consumption by the analytics consumer) based on the information received from the source NWDAF. The target NWDAF2 may allocate a new subscription correlation ID (e.g., subscription correlation ID 2) to the received/transferred analytics subscriptions.

In steps 13 and 14, the target NWDAF2 may inform/notify the analytics consumer about the successful analytics subscription transfer using a (e.g., Nnwdaf_EventsSubscription_Notify) request message. A new subscription correlation ID assigned/allocated by the target NWDAF2, the transferred analytics ID (e.g., analytics subscription ID 2), and the old subscription correlation ID assigned/allocated by the source NWDAF can be provided/included/identified in the (e.g., Nnwdaf_EventsSubscription_Notify) request message. The request message may also include the notification correlation ID which allows the analytics consumer to correlate the notifications to the initial subscription request made with the source NWDAF in step 1. The analytics consumer may send a response message (e.g., an Nnwdaf EventsSubscription Notify response) to the target NWDAF2 (e.g. in response to the request message).

In steps 15 and 16, the analytics consumer may modify or delete the analytics subscription (e.g., ID 3) at the source NWDAF by sending a request message (e.g., an Nnwdaf_EventsSubscription_Subscribe request or an Nnwdaf_EventsSubscription_Unsubscribe service operation). The analytics consumer may know/be aware of which subscription(s) can be still at the source NWDAF, based on the analytics ID(s) received in steps 10 & 11, and in steps 13 & 14. The request message may include the old subscription correlation ID assigned by the source NWDAF received by the analytics consumer in step 2. The source NWDAF may send a response message (e.g., an Nnwdaf_EventsSubscription_(un)Subscribe response) to the analytics consumer.

In steps 17 and 18, the analytics consumer may modify or delete an analytics subscription (e.g., ID 1) at the target NWDAF1 by sending a request message (e.g., an Nnwdaf_EventsSubscription_Subscribe or an Nnwdaf_EventsSubscription_Unsubscribe service operation). The analytics consumer may know/be aware of which subscription(s) can be at the target NWDAF1, based on the analytics subscription ID(s) received in steps 10 & 11. The request message may include the new subscription correlation ID assigned by the target NWDAF1 received by the analytics consumer in step 10. The target NWDAF1 may send a response message (e.g., an Nnwdaf_EventsSubscription_(un)Subscribe response) to the analytics consumer.

In steps 19 and 20, the analytics consumer may modify or delete an analytics subscription (e.g., ID 2) at the target NWDAF2 by sending a request message (e.g., an Nnwdaf_EventsSubscription_Subscribe or an Nnwdaf_EventsSubscription_Unsubscribe service operation). The analytics consumer may know/be aware of which subscription(s) can be at the target NWDAF2, based on the analytics subscription ID(s) received in steps 13 & 14. The request message may include the new subscription correlation ID assigned by the target NWDAF2 received by the analytics consumer in step 13. The target NWDAF2 may send a response message (e.g., an Nnwdaf_EventsSubscription_(un)Subscribe response) to the analytics consumer.

The target NWDAF1 and the target NWDAF2 may include an identification of the transferred analytics in the subscription change notification, which can enable the analytics consumer to identify which subscribed analytics are transferred and which are not, so that the analytics consumer can use the new subscription correlation ID for the transferred analytics subscriptions and use the old correlation subscription ID for the analytics subscriptions remaining with the source NWDAF.

### Implementation Example 4: Transferred Analytics are Further Transferred from a Target NWDAF to Another NWDAF

In step 1, an analytics consumer may send a request message (e.g., an Nnwdaf_EventsSubscription_Subscribe request) to subscribe to at least one (e.g., type of) analytics (e.g., analytics subscriptions IDs 1, 2, and 3) from a source NWDAF. The request may include the analytics being subscribed by the analytics consumer, a notification uniform resource identifier (URI), and/or a notification correlation ID.

In step 2, the source NWDAF may assign (e.g., generate, allocate) a subscription correlation ID associated with the at least one analytics subscription (e.g., analytics subscriptions IDs 1, 2, and 3). The source NWDAF may send a response message (e.g., an Nnwdaf_EventsSubscription_Subscribe response) to the analytics consumer. The response message may include the subscription correlation ID.

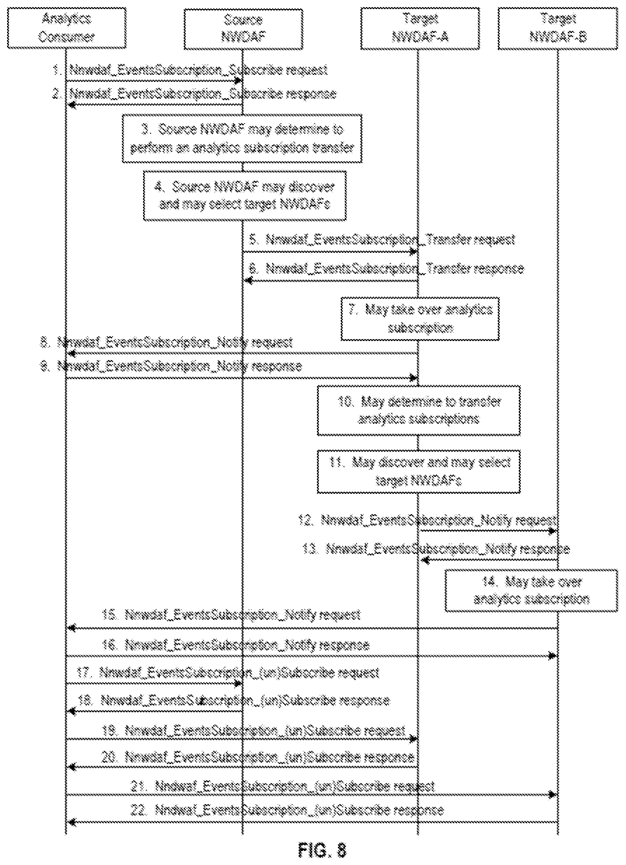

In some embodiments, a preparation step (not shown in FIG. 8) can be performed. The source NWDAF may determine to perform the preparation step. In the preparation step, the source NWDAF may discover one or more candidate target NWDAFs (e.g., NWDAF-Y and NWDAF-Z). The NWDAF may send a request message (e.g., Nnwdaf_EventsSubscription_Transfer) to the one or more candidate target NWDAFs. The request message may include an indication information (e.g., a prepared analytics subscription transfer indication) in the request message. The one or more candidate target NWDAFs (e.g., NWDAF-Y and NWDAF-Z) may start data collection from network functions (NFs) or operations, administration, and maintenance (OAM), and may start analytics generations for the indicated analytics subscriptions. The source NWDAF may determine to select a target NWDAF (e.g., NWDAF-Y) from the one or more candidate target NWDAFs. The source NWDAF may send a request message (e.g., Nnwdaf_EventsSubscription_Transfer) to the selected target NWDAF (e.g., NWDAF-Y) to ask the selected target NWDAF to take over at least one analytics subscription from the source NWDAF. The source NWDAF may cancel the prepared analytics subscription transfer to the other candidate target NWDAF-Z. The selected target NWDAF can take over the at least one analytics subscription from the source NWDAF in a short time if there is a preparation step.

In step 3, based on an external and/or an internal trigger, the source NWDAF may determine to initiate an analytics subscription transfer from the source NWDAF to one or more other NWDAFs. The source NWDAF may determine one or more (e.g., analytics subscription IDs 1 and 2) of the at least one analytics subscriptions to transfer, and may determine to perform an analytics subscription transfer (of the one or more determined analytics subscriptions) to a target NWDAF. The source NWDAF may determine one or more analytics subscriptions to be transferred to the target NWDAF, e.g., based on a load, capability, processing capacity of the source NWDAF and/or the target NWDAF.

In step 4, the source NWDAF may perform an NWDAF discovery and may select a target NWDAF-A (e.g., from a plurality of target/candidate NWDAFs). For example, the source NWDAF may select target NWDAF-A for the analytics ID 1 subscription and the analytics ID 2 subscription.

In step 5, the source NWDAF may send a request message (using an Nnwdaf_EventsSubscription_Transfer service operation) to transfer analytics subscriptions (e.g., ID 1 and ID 2) to the target NWDAF-A. The request message may include/identify/specify the analytics subscription ID 1 and ID 2 being transferred, a notification URI, and/or a notification correlation ID received by the source NWDAF in step 1 from the analytics consumer.

In step 6, the target NWDAF-A may send a response message (e.g., an Nnwdaf_EventsSubscription_Transfer response) to the source NWDAF (e.g., in response to the request message).

In step 7, the target NWDAF-A may accept a transfer of at least one analytics subscription (e.g., analytics subscription IDs 1 and 2) from the source NWDAF to the target NWDAF-A. The target NWDAF-A may take over/receive the at least one analytics subscription (e.g., to perform generation of the analytics for consumption by the analytics consumer) based on the information received from the source NWDAF. The target NWDAF-A may allocate a new subscription correlation ID (e.g., subscription correlation ID 1) to the received/transferred analytics subscriptions.

In steps 8 and 9, the target NWDAF-A may inform/notify the analytics consumer about the successful analytics subscription transfer using a (e.g., Nnwdaf_EventsSubscription_Notify) request message. A new subscription correlation ID assigned/allocated by the target NWDAF-A, the transferred analytics ID (e.g., a list of analytics subscription IDs comprising IDs 1 and 2), and the old subscription correlation ID assigned/allocated by the source NWDAF can be provided/included/identified in the (e.g., Nnwdaf_EventsSubscription_Notify) request message. The request message may also include the notification correlation ID which may allow the analytics consumer to correlate the notifications to the initial subscription request made with the source NWDAF in step 1. The analytics consumer may send a response message (e.g., an Nnwdaf EventsSubscription Notify response) to the target NWDAF-A (e.g. in response to the request message).

In some embodiments, the preparation step (not shown in FIG. 8) can be performed. The target NWDAF may determine to perform the preparation step. In the preparation step, the target NWDAF may discover one or more candidate target NWDAFs (e.g., NWDAF-E and NWDAF-F). The NWDAF may send a request message (e.g., Nnwdaf_EventsSubscription_Transfer) to the one or more candidate target NWDAFs. The request message may include an indication information (e.g., a prepared analytics subscription transfer indication) in the request message. The one or more candidate target NWDAFs (e.g., NWDAF-E and NWDAF-F) may start data collection from network functions (NFs) or operations, administration, and maintenance (OAM), and may start analytics generations for the indicated analytics subscriptions. The target NWDAF may determine to select a target NWDAF (e.g., NWDAF-E) from the one or more candidate target NWDAFs. The target NWDAF may send a request message (e.g., Nnwdaf_EventsSubscription_Transfer) to the selected target NWDAF (e.g., NWDAF-E) to ask the selected target NWDAF to take over at least one analytics subscription from the target NWDAF. The target NWDAF may cancel the prepared analytics subscription transfer to the other candidate target NWDAF-F. The selected target NWDAF can take over the at least one analytics subscription from the target NWDAF in a short time if there is a preparation step.

In step 10, based on an external and/or an internal trigger, the target NWDAF-A may determine to initiate an analytics subscription transfer from the target NWDAF-A to another target NWDAF. The target NWDAF-A may determine one or more (e.g., analytics subscription ID 2) of the at least one analytics subscriptions being transferred to the target NWDAF-A (e.g., analytics subscriptions IDs 1 and 2) to transfer, and may determine to perform an analytics subscription transfer (of the one or more determined analytics subscriptions) to another target NWDAF. The target NWDAF-A may determine one or more analytics subscriptions to be transferred to a target NWDAF-B, e.g., based on a load, capability, processing capacity of the source NWDAF, the target NWDAF-A, and/or the target NWDAF-B.

In step 11, the target NWDAF-A may perform an NWDAF discovery and may select a target NWDAF-B (e.g., from a plurality of target/candidate NWDAFs). For example, the target NWDAF-A may select a target NWDAF-B for the analytics subscription ID 2.

In step 12, the target NWDAF-A may send a request message (using an Nnwdaf_EventsSubscription_Transfer service operation) to transfer analytics subscription (with ID 2) to the target NWDAF-B. The request message may include/identify/specify the analytics subscription (ID 2) being transferred, a notification URI, and/or a notification correlation ID received by the source NWDAF in step 1 from the analytics consumer.

In step 13, the target NWDAF-B may send a response message (e.g., an Nnwdaf_EventsSubscription_Transfer response) to the target NWDAF-A (e.g., in response to the request message).

In step 14, the target NWDAF-B may accept a transfer of at least one analytics subscription (e.g., analytics subscription ID 2) from the target NWDAF-A to the target NWDAF-B. The target NWDAF-B may take over/receive the at least one analytics subscription (e.g., to perform generation of the analytics for consumption by the analytics consumer) based on the information received from the target NWDAF-A. The target NWDAF-B may allocate a new subscription correlation ID (e.g., subscription correlation ID 2) to the received/transferred analytics subscriptions.

In steps 15 and 16, the target NWDAF-B may inform/notify the analytics consumer about the successful analytics subscription transfer using a (e.g., Nnwdaf_EventsSubscription_Notify) request message. A new subscription correlation ID assigned/allocated by the target NWDAF-B, the transferred analytics ID (e.g., analytics subscription ID 2), and the old subscription correlation ID assigned/allocated by the source NWDAF can be provided/included/identified in the (e.g., Nnwdaf_EventsSubscription_Notify) request message. The request message may also include the notification correlation ID which may allow the analytics consumer to correlate the notifications to the initial subscription request made with the source NWDAF in step 1. The analytics consumer may send a response message (e.g., an Nnwdaf EventsSubscription Notify response) to the target NWDAF-B (e.g. in response to the request message).

In steps 17 and 18, the analytics consumer may modify or delete the analytics subscription (having ID 3) at the source NWDAF by sending a request message (e.g., an Nnwdaf_EventsSubscription_Subscribe request or an Nnwdaf_EventsSubscription_Unsubscribe service operation). The analytics consumer may know/be aware of which subscription(s) can be still at the source NWDAF, based on the list of analytics subscription IDs received in steps 8 & 9. The request message may include the old subscription correlation ID assigned by the source NWDAF received by the analytics consumer in step 2. The source NWDAF may send a response message (e.g., an Nnwdaf_EventsSubscription_(un)Subscribe response) to the analytics consumer.

In steps 19 and 20, the analytics consumer may modify or delete the analytics subscription (ID 1) at the target NWDAF-A by sending a request message (e.g., an Nnwdaf_EventsSubscription_Subscribe or an Nnwdaf_EventsSubscription_Unsubscribe service operation). The analytics consumer may know/be aware of which subscription(s) can be at the target NWDAF-A, based on the list of analytics subscription IDs received in steps 8 & 9, and the analytics subscription ID received in steps 15 & 16. The request message may include the new subscription correlation ID assigned by the target NWDAF-A received by the analytics consumer in step 8. The target NWDAF-A may send a response message (e.g., an Nnwdaf_EventsSubscription_(un)Subscribe response) to the analytics consumer.

In steps 21 and 22, the analytics consumer may modify or delete the analytics subscription (having ID 2) at the target NWDAF-B by sending a request message (e.g., an Nnwdaf_EventsSubscription_Subscribe or an Nnwdaf_EventsSubscription_Unsubscribe service operation). The analytics consumer may know/be aware of which subscription(s) can be at the target NWDAF-B, based on the list of analytics subscription IDs received in steps 8 & 9, and the analytics subscription ID received in steps 15 & 16. The request message may include the new subscription correlation ID assigned by the target NWDAF-B received by the analytics consumer in step 15. The target NWDAF-B may send a response message (e.g., an Nnwdaf_EventsSubscription_(un)Subscribe response) to the analytics consumer.

The target NWDAF-A and the target NWDAF-B may include/incorporate an identification of the transferred analytics in the subscription change notification, which can enable the analytics consumer to identify which subscribed analytics are transferred and which are not, so that the analytics consumer can use the new subscription correlation ID for the transferred analytics subscriptions and use the old correlation subscription ID for the analytics subscriptions remaining with the source NWDAF.

It should be understood that one or more features from the above implementation examples are not exclusive to the specific implementation examples, but can be combined in any manner (e.g., in any priority and/or order, concurrently or otherwise).

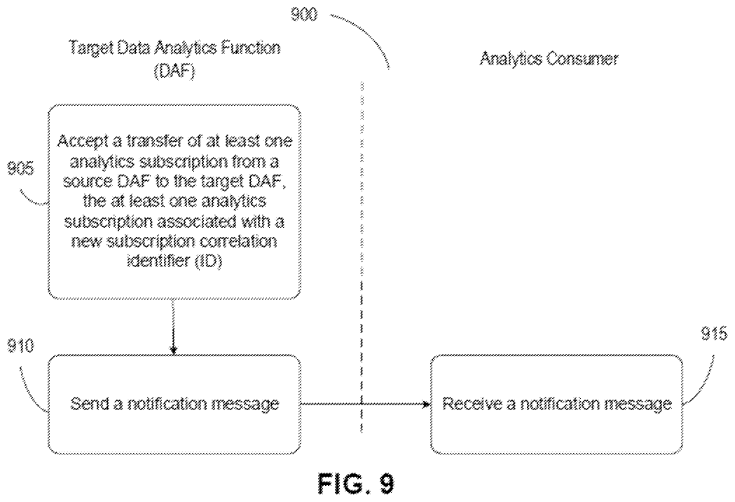

FIG. 9 illustrates a flow diagram for providing at least one analytics identifier (ID) in subscription change notifications, in accordance with an embodiment of the present disclosure. The method 900 may be implemented using any one or more of the components and devices detailed herein in conjunction with FIGS. 1-2. In overview, the method 900 may be performed by a target data analytics function (DAF), in some embodiments. Additional, fewer, or different operations may be performed in the method 900 depending on the embodiment. At least one aspect of the operations is directed to a system, method, apparatus, or a computer-readable medium.

A target data analytics function (DAF) (e.g., network data analytics function (NWDAF)) may accept a transfer of at least one analytics subscription from a source DAF to the target DAF. The at least one analytics subscription may be associated with a new subscription correlation identifier (ID) (e.g., allocated/assigned by the target NWDAF). The target DAF may send a notification message (e.g., a Nnwdaf_EventsSubscription_Notify request message) to an analytics consumer. The target DAF may comprise the new subscription correlation ID and an identification of the at least one analytics subscription being transferred. The identification of the at least one analytics subscription can include at least one of: an ID number, a name, a group number, an index of a table, or an item number. The notification message may further comprise at least one of: an old subscription correlation ID associated with (e.g., allocated/assigned by) the source DAF, or a notification correlation ID.

In some embodiments, the analytics consumer may determine to modify or delete at least one other analytics subscription (e.g., those analytics subscription(s) remaining with the source NWDAF), according to the identification of the at least one analytics subscription. The analytics consumer may send a request to the source DAF to modify or delete the at least one other analytics subscription.

In some embodiments, the analytics consumer may determine to modify or delete one or more of the at least one analytics subscription (e.g., those analytics subscription(s) transferred to the target NWDAF), according to the identification of the at least one analytics subscription. The analytics consumer may send a request to the target DAF to modify or delete the one or more of the at least one analytics subscription. In some embodiments, the at least one analytics subscription may consist of all analytics subscriptions that are subscribed by the analytics consumer from the source DAF.

In some embodiments, a second target DAF may accept a transfer of at least one other analytics subscription from the source DAF to the second target DAF. The at least one other analytics subscription can be associated with a second new subscription correlation identifier (ID). The second target DAF may send a second notification message to the analytics consumer. The second notification message may comprise the second new subscription correlation ID and an identification of the at least one other analytics subscription. The analytics consumer may determine to modify or delete the at least one other analytics subscription, according to the identification of the at least one analytics subscription. The analytics consumer may send a request to the second target DAF to modify or delete the at least one other analytics subscription.

In some embodiments, a second target DAF may accept a transfer of one or more analytics subscriptions of the at least one analytics subscription from the target DAF to the second target DAF. The one or more analytics subscriptions can be associated with a second new subscription correlation identifier (ID). The second target DAF may send a second notification message to the analytics consumer. The second notification message may comprise the second new subscription correlation ID and an identification of the one or more analytics subscription. The analytics consumer may determine to modify or delete the one or more analytics subscriptions, according to the identification of the one or more analytics subscriptions. The analytics consumer may send a request to the second target DAF to modify or delete the one or more analytics subscriptions.

In some embodiments, the analytics consumer may determine to modify or delete at least one analytics subscription remaining with the source DAF, according to the identification of the at least one analytics subscription. The analytics consumer may send a request to the source DAF to modify or delete the at least one analytics subscription remaining with the source DAF.

In some embodiments, the analytics consumer may determine to modify or delete at least one analytics subscriptions remaining with the target DAF, according to the identification of the at least one analytics subscription (e.g., identifying those transferred to the target DAF) and the identification of the one or more analytics subscriptions (e.g., identifying those transferred to the second target DAF). The analytics consumer may send a request to the target DAF to modify or delete the at least one analytics subscriptions remaining with the target DAF.

In some embodiments, an analytics consumer may receive a notification message (e.g., a Nnwdaf_EventsSubscription_Notify request message) from a target data analytics function (DAF). The notification message may comprise (i) a new subscription correlation identifier (ID) associated with at least one analytics subscription transferred from a source DAF to the target DAF, and (ii) an identification of the at least one analytics subscription.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
receiving, by a target data analytics function (DAF) from a source DAF, a request message to transfer at least one analytics subscription from the source DAF to the target DAF, the at least one analytics subscription associated with a new subscription correlation identifier (ID); and
sending, by the target DAF to an analytics consumer, a notification message comprising the new subscription correlation ID and an identification of the at least one analytics subscription.

2. The method of claim 1, wherein the notification message further comprises at least one of: an old subscription correlation ID associated with the source DAF, or a notification correlation ID.

3. A method, comprising:
receiving, by an analytics consumer from a target data analytics function (DAF), a notification message comprising: (i) a new subscription correlation identifier (ID) associated with at least one analytics subscription transferred from a source DAF to the target DAF, and (ii) an identification of the at least one analytics subscription.

4. The method of claim 3, wherein the notification message further comprises at least one of: an old subscription correlation ID associated with the source DAF, or a notification correlation ID.

5. A target data analytics function (DAF), comprising:
at least one processor configured to:
receive, via a transceiver from a source DAF, a request message to transfer at least one analytics subscription from the source DAF to the target DAF, the at least one analytics subscription associated with a new subscription correlation identifier (ID); and
send, via the transceiver to an analytics consumer, a notification message comprising the new subscription correlation ID and an identification of the at least one analytics subscription.

6. The target DAF of claim 5, wherein the notification message further comprises at least one of: an old subscription correlation ID associated with the source DAF, or a notification correlation ID.

7. An analytics consumer, comprising:
at least one processor configured to:
receive, via a receiver from a target data analytics function (DAF), a notification message comprising: (i) a new subscription correlation identifier (ID) associated with at least one analytics subscription transferred from a source DAF to the target DAF, and (ii) an identification of the at least one analytics subscription.

8. The analytics consumer of claim 7, wherein the notification message further comprises at least one of: an old subscription correlation ID associated with the source DAF, or a notification correlation ID.

9. A non-transitory computer readable storage medium storing instructions, which when executed by one or more processors can cause the one or more processors to perform the method of claim 1.

10. A non-transitory computer readable storage medium storing instructions, which when executed by one or more processors can cause the one or more processors to perform the method of claim 2.

11. A non-transitory computer readable storage medium storing instructions, which when executed by one or more processors can cause the one or more processors to perform the method of claim 3.

12. A non-transitory computer readable storage medium storing instructions, which when executed by one or more processors can cause the one or more processors to perform the method of claim 4.
